(19) United States
(12) Patent Application Publication
(10) Pub. No.: US 2010/0164251 A1
(43) Pub. Date: Jul. 1, 2010

(54) Sturcture and connection member for structure

(76) Inventor: Tatsushi Itou, Osaka (JP)

Correspondence Address: WENDEROTH, LIND & PONACK, L.L.P., 1030 15th Street, N.W.,, Suite 400 East, Washington, DC, 20005-1503, US

(21) Appl. No.: 11/920,554

(22) PCT Filed: Mar. 23, 2006
(86) PCT No.: PCT/JP2006/305834

§ 371 Date: Oct. 29, 2009

(30) Foreign Application Priority Data
May 19, 2005 (JP) 2005-146610

(51) Int. Cl. B62D 25/20; F16B 7/00

(52) U.S. Cl. 296/205; 403/271

(57) ABSTRACT

A structure formed by welding one component member and other component member through a connection member, the connection member which includes: a one side connection end portion including a junction portion having a shape matching an outer surface of the one component member, the one side connection end portion being contacted to the one component member, being freely moved along an axial direction of the one component member, and being welded to the one component member, and an other side connection end portion including an engaging portion that is fitted into the other component member and can be relatively freely moved along a direction intersecting with the axial direction of the one component member, and being welded to the other component member.

### TECHNICAL FIELD

The present invention relates to a structure formed by joining one component member and other component member through a connection member using welding. Additionally, the present invention also relates to the connection member for the structure stated above.

### BACKGROUND ART

The conventional hydraulic excavator A shown in FIG. 5 comprises a lower carriage B having a crawler type traveling mechanism, and an upper revolving body C that is mounted on and supported by the lower carriage B. The upper revolving body C is provided with a work equipment D and an operator cabin E.

The operator cabin of industrial vehicles, such as a construction machine and an agricultural machinery, has a frame structure (structure). This frame structure is usually formed by joining deformed steel pipes or other component members to each others (for example, see Patent Literature 1).

As shown in FIG. 6, in a frame structure H of the operator cabin E stated above, a left front pillar LF and a left rear pillar LB, which are placed and stand on a base I, are connected each other through a left roof pillar LT, while a right front pillar RF and a right rear pillar RB, which are placed and stand on the base I, are connected each other through a right roof pillar RT. Upper portions of these left and right frames are joined each other through a front roof beam M and a rear roof beam N, which extend transversely.

Additionally, connection between the left front pillar LF and the left roof pillar LT, and connection between the left roof pillar LT and the left rear pillar LB are made through each joint LJ, while connection between the right front pillar RF and the right roof pillar RT, and connection between the right roof pillar RT and the right rear pillar RB are made through each joint RJ.

In the joint LJ that joins the left rear pillar LB and the left roof pillar LT, a plug LJb provided below an elbow LJe is fitted into the left rear pillar LB, and the left rear pillar LB is welded to the elbow LJe. Additionally, a plug LJt provided in front of the elbow LJe is fitted into the left roof pillar LT, and the left roof pillar LT and the elbow LJe are welded. As a result, the left rear pillar LB is joined to the left roof pillar LT. It is needless to say that the joints of other three portions have the configuration similar to the joint LJ described above.

Patent Literature 1: Japanese Patent Application Laid-Open No. 2000-198468

### DISCLOSURE OF THE INVENTION

### Problems to be Solved by the Invention

Incidentally, as described above, in the conventional frame structure H in which the joints are used to join the pillars (component members) to each other, for example, there is no flexibility for adjusting the positional relationship between the left rear pillar LB and the left roof pillar LT assembled through the joint LJ in a state where all the pillars and joints are temporarily joined. Thus, in a case of a slight error in a shape (dimension) of each of the pillar or the joints, there may occur a large stress in each part of the frame structure that is temporarily joined, resulting in a possibility of deformation in the completed frame construction after welding.

Therefore, in the conventional frame structure that uses the joints for joining each of pillars (component members), extremely higher accuracy is required for the shape (dimension) of each of the pillars LF, LT, LB, RF, RT, RB and the joints LJ, RJ, which causes problems of increased manufacturing costs, complexity of processes, and deterioration in productivity.

In view of the above circumstance, it is an object of the present invention to provide a structure and a connection member for the structure that can achieve the significant improvement of productivity.

### Means to Solve the Problems

To achieve the object above, a first aspect of the present invention provides a structure formed by welding one component member and other component member through a connection member, the connection member which includes: a one side connection end portion including a junction portion having a shape matching an outer surface of the one component member, the one side connection end portion being contacted to the one component member, being freely moved along an axial direction of the one component member, and being welded to the one component member, and an other side connection end portion including an engaging portion that is fitted into the other component member and can be relatively freely moved along a direction intersecting with the axial direction of the one component member, and being welded to the other component member.

A second aspect of the present invention provides the structure according to the first aspect of the present invention, wherein the structure is a frame structure forming an operator cabin of a work vehicle.

A third aspect of the present invention provides a connection member of a structure formed by welding one component member and other component member through the connection member, the connection member which includes: a one side connection end portion including a junction portion having a shape matching an outer surface of the one component member, the one side connection end portion being contacted to the one component member, being freely moved along an axial direction of the one component member, and being welded to the one component member, and an other side connection end portion including an engaging portion that is fitted into the other component member and can be relatively freely moved along a direction intersecting with the axial direction of the one component member, and being welded to the other component member.

A fourth aspect of the present invention provides the connection member of the structure according to the third aspect of the present invention, wherein the structure is a frame structure forming an operator cabin of a work vehicle.

### EFFECTS OF THE INVENTION

According to the structure of the first aspect of the present invention, when one component member is temporarily joined to other component member through a connection member, the other component member can be moved in a longitudinal direction of and toward/away from the one component member, and a positional relationship between the one component member and the other component member can be adjusted. Additionally, the excess stress is prevented from occurring in the structure which is under the state of being temporarily joined even when there exists a slight error in the shape (dimension) of each of the component members. Therefore, the structure with a desired shape not having distortion can be obtained by joining each of the component members using welding without requiring higher accuracy for the shape (dimension) of each of the component members. Accordingly, significant improvement in the productivity can be achieved.

According to the structure of the second aspect of the present invention, the productivity of the frame structure configuring an operator cabin can be significantly improved.

According to the connection member for the structure of the third aspect of the present invention, when one component member is temporarily joined to other component member through the connection member, the other component member can be moved in a longitudinal direction of and toward/away from the one component member, and a positional relationship between the one component member and the other component member can be adjusted. Additionally, the excess stress is prevented from occurring in the structure which is under the state of being temporarily joined even when there exists a slight error in the shape (dimension) of each of the component members. Therefore, the structure with a desired shape not having distortion can be obtained by joining each of the component members using welding without requiring higher accuracy for the shape (dimension) of each of the component members. Accordingly, significant improvement in the productivity can be achieved.

According to the connection member for the structure of the fourth aspect of the present invention, the productivity of the frame structure configuring an operator cabin can be significantly improved.

### BEST MODE FOR CARRYING OUT THE INVENTION

Hereinbelow, the present invention will be described in detail based on the figures showing an embodiment.

FIG. 1 shows an embodiment in which the present invention is applied to a frame structure configuring an operator cabin of the hydraulic excavator (working vehicle). A cab seat is configured by attaching a prescribed outer panel to a prescribed portion of the outer surface of the frame structure (structure) 1. It should be noted that the entire configuration of the hydraulic excavator is the same as the general type of the hydraulic excavator as shown in FIG. 5.

The frame structure 1 is made up of a base frame 2, a left side frame 5L that is integrally formed by a left front pillar 3L and a left roof pillar 4L, a right side frame 5R that is integrally formed by a right front pillar 3R and a right roof pillar 4R, a left rear pillar 6L, a right rear pillar 6R, and so on.

Then, in the frame structure 1, the left side frame 5L that is placed and stands on the base frame 2 is joined to an upper portion of the left rear pillar 6L, and the right side frame 5R that is placed and stands on the base frame 11 is joined to an upper portion of the right rear pillar 6R. Additionally, the left side frame 5L and the right side frame 5R are connected with a front roof beam 7F and a middle roof beam 7M, and the left rear pillar 6L and the right rear pillar 6R are connected with an upper rear beam 8T, a middle rear beam 8M and a lower rear beam 8B.

Additionally, in the frame structure 1, the upper portion of the left rear pillar 6L (one component member) is joined through a left connection member 10L to the left roof pillar 4L (other component member) of the left side frame 5L, while the upper portion of the right rear pillar 6R (one component member) is joined through a left connection member 10R to the right roof pillar 4R (other component member) of the right side frame 5R.

It should be noted that, since the left connection member 10L and the right connection member 10R are arranged in mirror-image symmetry with respect to central longitudinal plane and the basic configurations of those members are identical with each other, description will be made hereinafter of the configuration of the left connection member 10L, and the joined mode between the left rear pillar 6L and the left roof pillar 4L with the aid of the connection member 10L.

As shown in FIGS. 2 through 4, the connection member 10L described above is a member manufactured by performing press machining (steel metal working) of metal plates (steel plates), and has one side connection end portion 11 that is welded to the left rear pillar 6L; and other side connection end portion 12 that is welded to the left roof pillar 4L. It should be noted that the connection member 10 may be manufactured not by performing press machining of metal plates, but by casting with cast iron or cast steel. Additionally, in FIGS. 2 through 4, an arrow F indicates the forward direction of the frame structure 1.

The one side connection end portion 11 in the connection member 10L comprises a junction portion 11A having a shape matching an outer surface of the left rear pillar 6L formed from a square steel pipe, more specifically, matching a corner portion including a front surface 6Lf and an outward surface 6Lo of the left rear pillar 6L. The junction portion 11A comprises a contacting part 11a facing the front surface 6Lf of the left rear pillar 6, and a contacting part 11b facing the outward surface 6Lo of the left rear pillar 6L.

The other side connection end portion 12 in the connection member 10L comprises an engaging portion 12A fitted in a hollow portion of the left roof pillar 4L formed from a deformed steel pipe. The engaging portion 12A is formed in a sectional shape matching the hollow portion of the left roof pillar 4L stated above.

In a state where all the component members in the frame structure 1 are temporarily assembled, the junction portion 11A of the one side connection end portion 11 in the above connection member 10L is contacted to the outer surface of a prescribed portion in the left rear pillar 6L while the engaging portion 12A of the other side connection end portion 12 in the above connection member 10L is contacted to the rear end portion of the left roof pillar 4L.

In this state, the connection member 10L in which the junction portion 11A of the one side connection end portion 11 is contacted to the outer surface of the left rear pillar 6L can be freely moved along the axial direction (vertical direction) of the above left rear pillar 6L, as shown in an arrow v in FIG. 4B. Thus, the positional relationship between the left roof pillar 4L fitted to the connection member 10L and the above left rear pillar 6L can be adjusted in the axial direction of the left rear pillar 6L.

Additionally, in this state, the left roof pillar 4L fitted to the engaging portion 12A of the other side connection end portion 12 can be freely moved along the axial direction (back and forth direction) of the left roof pillar 4L as shown in an arrow h in FIG. 4A, in other words, can be freely moved in a direction that intersects with the axial direction of the left rear pillar 6L to which the connection member 10L is contacted. Thus, the positional relationship of the left roof pillar 4L can be adjusted toward/away from the above left rear pillar 6L.

Therefore, even when there exists a slight error in the shape (dimension) of each of the component members in the frame structure 1, excess load can be prevented in advance from occurring in the frame structure 1 in the state of temporary assemble by adjusting the positional relationship between the component members using the connection members as described above.

As a result, without requiring extremely high accuracy in shape (accuracy in dimension) for each of the component members, a deformation-free frame structure 1 can be manufactured in a prescribed shape by welding each of the component members, whereby it is possible to realize the significant improvement in the productivity.

On the other hand, after the component members in the frame structure are temporarily assembled and the positional relationship of each of the component members is adjusted, the above left rear pillar 6L and the left roof pillar 4L are integratedly joined by welding the one side connection end portion 11 of the connection member 10L to the outer surface of the left rear pillar 6L while welding a header of the left roof pillar 4L to the other side connection end portion 12 of the connection member 10L.

Since the junction portion 11A of the one side connection end portion 11 in the connection member 10L covers the corner portion of the left rear pillar 6L, the welded area (length of weld line) with respect to the left rear pillar 6L can be increased, whereby the welding strength between the connection member 10 L and the left rear pillar 6L can be improved.

Additionally, since the engaging portion 12A of the other side connection end portion 12 in the connection member 10L is fitted into the left roof pillar 4L, the welded area (length of weld line) covering all around the header of the left roof pillar 4L can be increased, whereby the welding strength between the connection member 10L and the left roof pillar 4L can be improved.

Furthermore, the junction portion 11A of the one side connection end portion 11 in the connection member 10L is faced to the front surface 6Lf of the left rear pillar 6L while the junction portion 11B is faced to the outward surface 6Lo. Thus, each of the external force from the rear direction as shown in an arrow Wb in FIG. 2B and that from the side (left side) direction as shown in an arrow W1 in FIG. 2B can be received by the left rear pillar 6L and the left roof pillar 4L, whereby the strength of the frame structure 1 can be significantly improved.

Additionally, by manufacturing the frame structure 1 as described above, a step of temporarily assembling all of the component members of the frame structure 1 and a step of welding the assembled component members can be completely separated. Thus, each of the steps can be integrated, whereby productivity can be significantly improved.

It should be noted that, in the embodiment as described above, the present invention is applied to a frame structure of an operator cabin in a hydraulic excavator. However, the present invention, needless to say, may be effectively applicable to a frame structure of an operator cabin in various industrial vehicles other than the hydraulic excavator stated above. Furthermore, it is also needless to say that the present invention may be effectively applicable to various structures other than the frame structure of the operator cabin.

### BRIEF DESCRIPTION OF THE DRAWINGS

FIG. 1 is an overall outlined perspective view showing an embodiment in which the present invention is applied to the frame structure of the operator cabin in the industrial vehicle.

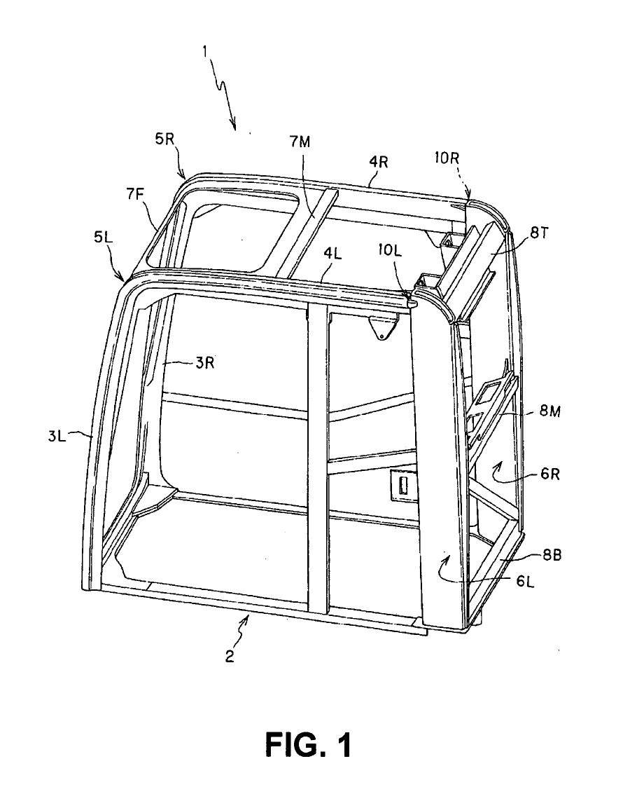

FIGS. 2A and 2B are fragmental side view and fragmental plan view as shown in FIG. 1, respectively.

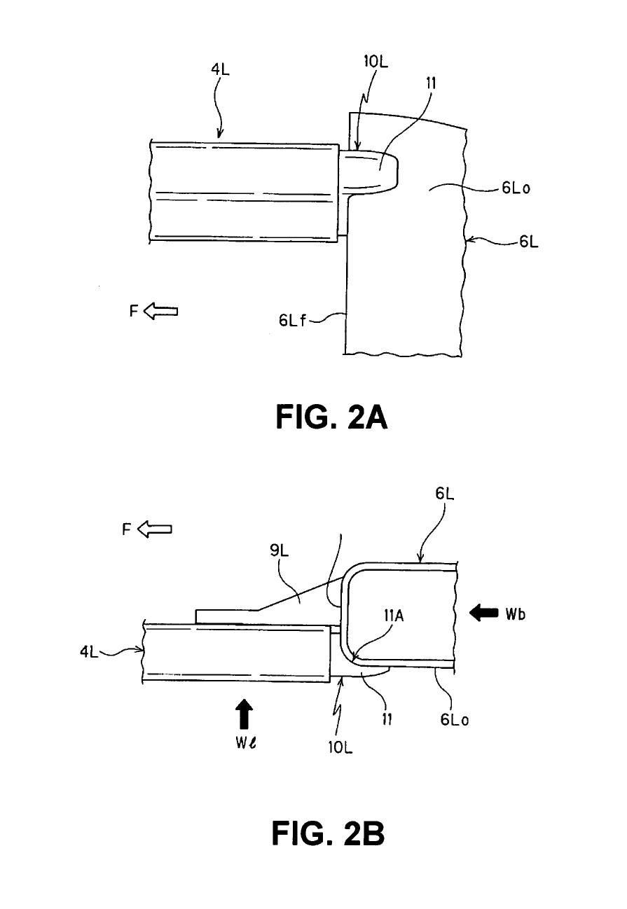

FIG. 3 is an exploded perspective view showing the frame structure shown in FIG. 1 and the connection member.

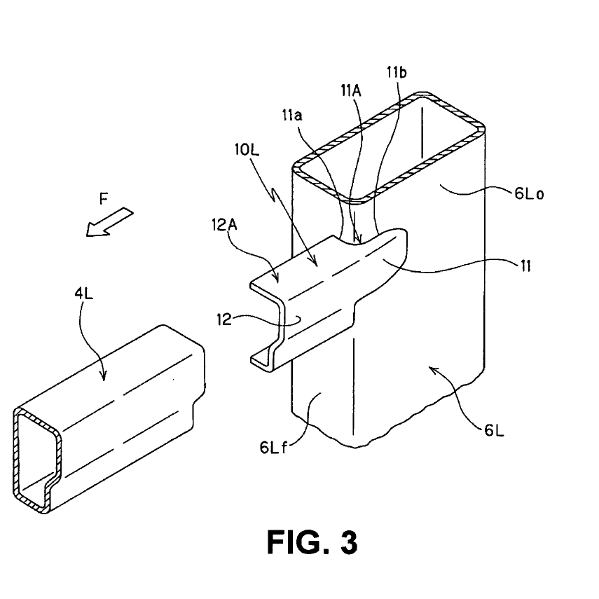

FIGS. 4A and 4B are overall plan views of the connection member of the frame structure shown in FIG. 1.

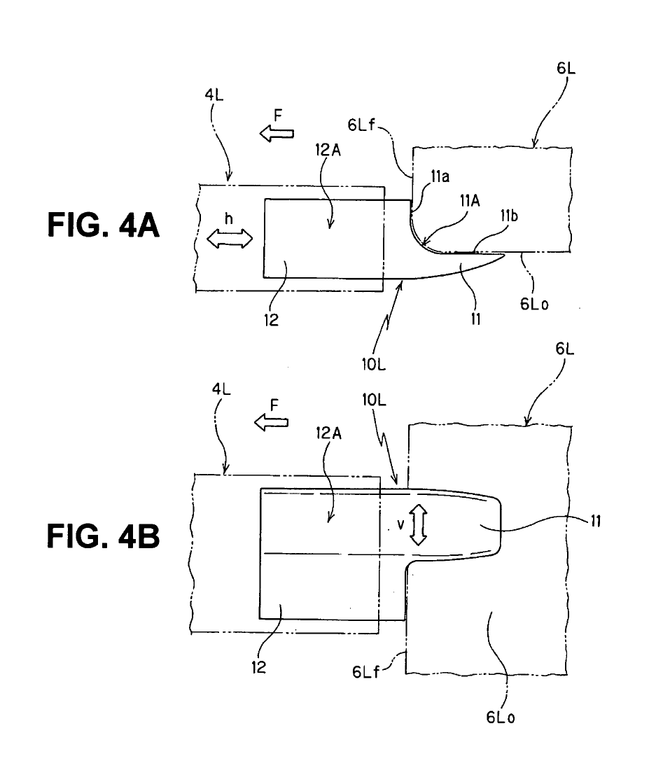

FIG. 5 is an overall conceptual side view showing a general industrial vehicle.

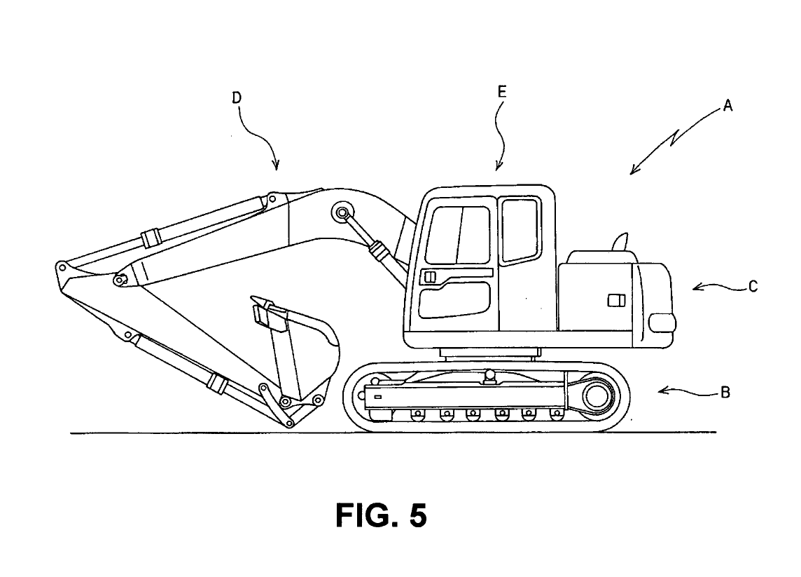

FIG. 6 is an outlined perspective view showing the frame structure of the operator cabin in the conventional industrial vehicle.

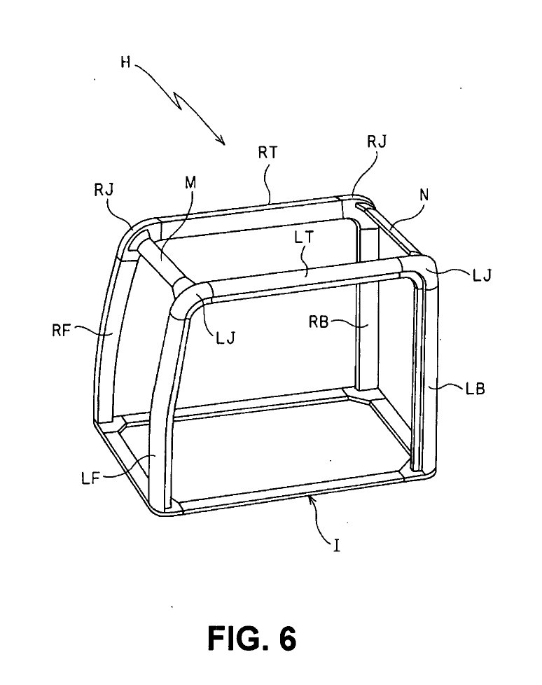

FIG. 7 is an exploded perspective view showing the frame structure shown in FIG. 6 and a joint.

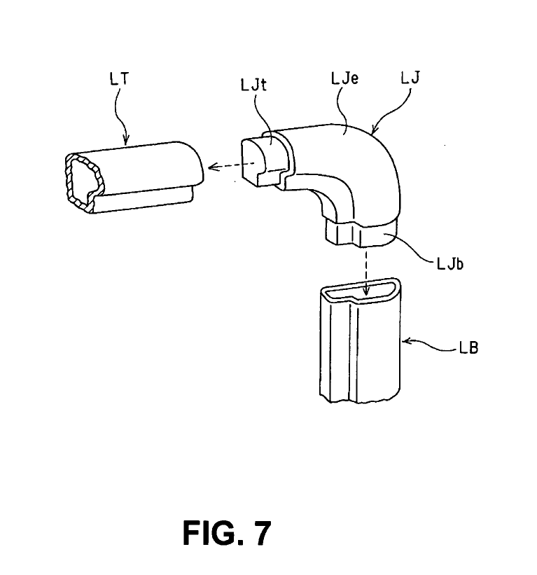

### EXPLANATION OF REFERENCE NUMERALS

1 frame structure (structure)
6L left rear pillar (one component member)
6R right rear pillar (one component member)
4L left roof pillar (other component member)
4R right roof pillar (other component member)
10L, 10R connection member
11 one side connection end portion
11A junction portion
12 other side connection end portion
12A engaging portion

1. A structure formed by welding one component member and other component member through a connection member, the connection member comprising:
a one side connection end portion including a junction portion having a shape matching an outer surface of the one component member, the one side connection end portion being contacted to the one component member, being freely moved along an axial direction of the one component member, and being welded to the one component member, and
an other side connection end portion including an engaging portion that is fitted into the other component member and can be relatively freely moved along a direction intersecting with the axial direction of the one component member, and being welded to the other component member.

2. The structure according to claim 1, wherein
the structure is a frame structure forming an operator cabin of a work vehicle.

3. A connection member of a structure formed by welding one component member and other component member through the connection member, the connection member comprising:
a one side connection end portion including a junction portion having a shape matching an outer surface of the one component member, the one side connection end portion being contacted to the one component member, being freely moved along an axial direction of the one component member, and being welded to the one component member, and
an other side connection end portion including an engaging portion that is fitted into the other component member and can be relatively freely moved along a direction intersecting with the axial direction of the one component member, and being welded to the other component member.

4. The connection member of the structure according to claim 3, wherein
the structure is a frame structure forming an operator cabin of a work vehicle.
